(19) United States
(12) Patent Application Publication
(10) Pub. No.: US 2008/0278413 A1
(43) Pub. Date: Nov. 13, 2008

(54) Plasma display apparatus

(75) Inventors: Takashi Shiizaki, Yokohama (JP); Hidenori Ohnuki, Kawasaki (JP); Satoshi Yuri, Yokohama (JP); Tetsuya Kaminaka, Yokohama (JP); Hirohito Kuriyama, Yokohama (JP); Tomokatsu Kishi, Yokosuka (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 11/907,867

(22) Filed: Oct. 18, 2007

(30) Foreign Application Priority Data
May 9, 2007 (JP) 2007-124808

(51) Int. Cl. G09G 3/28

(52) U.S. Cl. 345/60

(57) ABSTRACT

A plasma display apparatus includes a plurality of electrodes and a driver circuit configured to drive the plurality of electrodes, wherein the driver circuit includes a plurality of driver ICs coupled in common to an electrode with respect to each of the plurality of electrodes, and the plurality of driver ICs supply electric currents to said electrode in a temporally staggered manner so as to drive each of the plurality of electrodes.

### BACKGROUND OF THE INVENTION

1. Field of the Invention

The present invention generally relates to plasma display apparatuses for displaying images, and particularly relates to a plasma display apparatus provided with drive circuits for driving a plurality of electrodes.

2. Description of the Related Art

Plasma display apparatus is known as an apparatus that is provided with address electrodes, sustain electrodes (hereinafter referred to as “X electrodes”), and scan electrodes (hereinafter referred to as “Y electrodes”), and displays an image on a display screen by driving these electrodes to generate electric discharge in gas and to utilize light emission associated with such electric discharge (see Japanese Patent Application Publication No. 2005-121718, for example).

FIG. 1 is a drawing showing a basic configuration of a related-art surface-discharge-type plasma display apparatus provided with three-types of electrodes.

In FIG. 1, a plasma display apparatus 200 includes a plasma display panel 10, X electrodes (X1, X2, X3, . . . ), Y electrodes (Y1, Y2, Y3, . . . ) disposed next to and extending parallel to the X electrodes, and address electrodes (A1, A2, A3, . . . ) disposed perpendicularly to the X and Y electrodes.

The X electrodes and Y electrodes are disposed on a first substrate (not shown) constituting part of the plasma display panel 10, and have their surfaces covered with a dielectric layer. The address electrodes are disposed on a second substrate opposing the first substrate, and have their surfaces also covered with a dielectric layer. Barrier ribs are provided on the second substrate between the address electrodes to extend parallel to the address electrodes. After forming a fluorescent layer in grooves between these barrier ribs, the first substrate and the second substrate are glued together such that a gap of a predetermined size is maintained therebetween, thereby forming a discharge space between the two substrates. This discharge space is filled with discharge gas that is a mixture of Neon and Xenon, for example, so that a display cell is formed at an intersection of an X electrode, an adjacent Y electrode forming a pair with this X electrode, and an address electrode.

As shown in FIG. 1, the address electrodes are coupled to an address driver 20, the Y electrodes coupled to a Y scan driver 30, and the X electrodes coupled to an X sustain circuit 60. These circuits drive the respective electrodes. The Y scan driver 30 is coupled to a Y sustain circuit 40, such that drive signals generated by the Y sustain circuit 40 are supplied to the Y electrodes through the Y scan driver 30.

The address driver 20, the X sustain circuit 60, the Y scan driver 30, and the Y sustain circuit 40 are each coupled to a control circuit 70. The control circuit 70 performs drive control for all the electrodes, and controls electric discharge for the purpose of controlling the displaying of the plasma display panel 10.

The X sustain circuit 60 has only one output, which controls all the X electrodes connected to this common output in a single uniform manner. On the other hand, the address driver 20 controls each address electrode separately from one another, and the Y scan driver 30 controls each Y electrode separately from one another.

FIG. 2 is a drawing showing the drive waveforms of the plasma display apparatus 200 shown in FIG. 1. A basic drive sequence of the plasma display apparatus 200 of an addressing-&-displaying separation type is comprised of a reset period for placing all the display cells in a uniform state, an address period for selecting display cells to emit light, and a sustain period for causing the selected display cells to emit light.

In the reset period, as shown in FIG. 2, voltage Va is applied to all the address electrodes, and Vw is applied to all the X electrodes, with 0 V applied to all the Y electrodes. With this voltage arrangement, electric discharge is generated at all the display cells between the X electrodes, the address electrodes, and the Y electrodes, so that all the display cells are placed in a uniform state.

In the address period that follows, voltage Vx is applied to all the X electrodes, and −Vy1 is applied to all the Y electrodes. Placed in this setting, the Y electrodes are successively applied with a −Vy scan pulse, so that address discharge is generated between the Y electrode applied with a scan pulse and an address electrode applied with an address pulse. This results in wall charge being accumulated, on the surface of the dielectric layer disposed on the electrodes of the display cells that are to emit light. Address pulses are applied to the address electrodes while scan pulses are successively applied to the Y electrodes, thereby selecting the display cells that are to emit light.

In the sustain period, sustain pulses of voltage Vs are alternately applied to the Y electrodes and the X electrodes while voltage Va is applied to the address electrodes. In the display cells at which wall charge is generated during the address period, a voltage made by the wall charge is added to voltage Vs of a sustain pulse, so that the total voltage exceeds a firing voltage, thereby generating sustain discharge. In the display cells at which wall charge is not generated during the address period, no voltage exceeding the firing voltage appears, so that no sustain discharge occurs. In the display cells at which sustain discharge occurs, wall charge having an opposite polarity is created by the sustain discharge. When a next sustain pulse is applied to the X electrodes, next sustain discharge occurs. Thereafter, sustain pulses are repeatedly applied to continue discharges.

As described above, the drive sequence of the plasma display apparatus 200 includes the address period and the sustain period. With respect to the Y electrodes, the Y scan driver 30 and the Y sustain circuit 40 serve to achieve the respective operations corresponding to these periods. In the address period, there is a need to drive each of the Y scan electrodes one after another, so that a driver IC capable of driving each electrode separately from one another is used. The Y scan driver 30 shown in FIG. 1 serves to achieve this function. In the sustain period, on the other hand, there is no need to drive each of the Y scan electrodes one after another, so that a driver circuit for applying a common voltage to a plurality of electrodes is used. The Y sustain circuit 40 shown in FIG. 1 serves to achieve this function.

A technology that provides a power recovery circuit for a Y-electrode drive circuit comprised of the Y scan driver 30 and the Y sustain circuit 40 is known (see Japanese Patent Application Publication No. 2003-330405, for example).

FIG. 3 is a drawing showing an example of the configuration of a Y-electrode drive circuit provided with a related-art power recovery circuit. A specific example of the Y-electrode drive circuit 55 is illustrated that has two paths for power recovery and that applies sustain voltages Vs and −Vs alternately to the X electrodes and the Y electrodes.

In FIG. 3, the Y-electrode drive circuit 55 includes the Y scan driver 30 and the Y sustain circuit 40. A reset circuit for generating a reset signal is omitted in this illustration. CL represents a capacitive load of a Y electrode.

In FIG. 3, the Y scan driver 30 is comprised of individual drivers each provided for a corresponding one of the Y electrodes. Each individual driver includes transistors Q1 and Q2 and diodes D31 and D32 disposed in parallel to these transistors. Namely, the scan driver shown in FIG. 3 is one individual driver corresponding to one electrode. In the scan period described in connection with FIG. 2, the on/off state of the transistors Q1 and Q2 is controlled so as to apply a scan pulse to the electrode CL functioning as a capacitive load.

The sustain circuit 40 includes transistors CU and CD, which are coupled to a sustain power supply. The transistor CU is a device for outputting positive polarity voltage Vs of the sustain power supply, and the transistor CD is a device for outputting negative polarity voltage −Vs of the sustain power supply. The gates of the transistors CU and CD are coupled to phase adjustment circuits 41 and 42, respectively. Sustain signals CUG and CDG are supplied to the respective phase adjustment circuits 41 and 42, which adjust the phases of these signals for provision to the gates of the transistors CU and CD, respectively.

The sustain circuit 40 includes a power recovery circuit. This power recovery circuit includes a condenser C10, a coil L10, a coil L20, a diode D33, a diode D34, and transistors LU and LD, which are parts of the Y sustain circuit 40. One end of C10 is connected to the ground. The other end of C10 is coupled to the transistor Q1 of the Y scan driver 30 via the transistor LU, the diode D33, and the coil L10, and is also coupled to the transistor Q2 via the transistor LD, the diode D34, and the coil L20. Signals LUG and LDG are supplied to the gates of the transistors LU and LD, respectively, and are also phase-adjusted by respective phase adjustment circuits 43 and 44 prior to input into these gates.

FIG. 4 is a drawing showing an example of a sustain voltage waveform and an electric current waveform appearing in the Y-electrode drive circuit 55 provided with the above-described power recovery circuit.

FIG. 4-(a) shows an example of a sustain voltage waveform. In the sustain period for outputting sustain voltages, the output of the Y scan driver 30 is fixed to LOW, and the sustain voltage waveform as shown in FIG. 4-(a) is supplied to the Y scan electrode by passing through the Y scan driver 30.

In FIG. 4-(a), the transistor LU is first turned on. In response, a LC resonance occurs based on the coil L10 and the capacitive load CL, so that the voltage waveform gently rises due to the LC resonance. The transistor CU is turned on when the voltage reaches a certain level, thereby outputting the sustain voltage Vs. The output voltage Vs is thereafter maintained until the transistor LD is turned on to lower the voltage. In this instance, an LC resonance occurs based on the coil L20 and the capacitive load CL, so that the sustain voltage output drops gently. The transistor CD is turned on when the voltage drops to a certain level, thereby outputting the negative-polarity sustain voltage −Vs.

FIG. 4-(a) shows a sustain current waveform corresponding to the sustain voltage waveform shown in FIG. 4-(a). A sustain current is a large current in the order of amperes. When such a large current runs through the Y scan driver 30, the Y scan driver 30 generates heat.

In order to prevent such generation of heat, an arrangement may be made such that the Y scan driver 30 is divided into a plurality of circuits connected in parallel to each other, thereby distributing the electric current to the plurality of circuits (see Japanese Patent Application Publication No. 2005-121718).

FIG. 5 is a drawing showing the relationships between the Y electrodes and the output nodes of the driver ICs of the related-art Y scan driver 30.

In FIG. 5, an output terminal O1 of a driver IC 21-1 and an output terminal O1 of a driver IC 21-2 are connected to each other to drive a scan electrode Y1, for example. Namely, two driver ICs are used to drive one scan electrode.

In this manner, the parallel connection of plural driver ICs of the Y scan driver 30 for the purpose of driving a single electrode makes it possible to distribute the electric current and thereby to suppress heat generation.

### SUMMARY OF THE INVENTION

In the configuration disclosed in Japanese Patent Application Publication No. 2005-121718 described above, a plurality of scan drivers are connected in parallel for each single electrodes, so that the number of driver ICs increases. When two scan drivers are connected in parallel for each electrode, for example, the number of devices doubles, resulting in a circuit cost increase.

In the configuration disclosed in Japanese Patent Application Publication No. 2005-121718, further, there is a need for each of the scan drivers connected in parallel to produce their output at the same timing for provision to the same electrode. If there is a displacement in the rising edge and/or falling edge of the drive signals, the switching transistor on the high-potential side of one driver IC may be turned on simultaneously with the switching transistor on the low-potential side of another driver IC, which results in the flowing of a through current for a short period of time. In order to avoid such instance, extreme precaution and care must be taken such as to make sure that all the wires have exactly the same length, for example.

Accordingly, it is an object of the present invention to provide a plasma display apparatus with suppressed heat generation and reduced cost, for which heat generation is suppressed while decreasing the number of devices used in the drive circuit.

In order to achieve the above object, a plasma display apparatus according to a first invention includes:

a plurality of electrodes; and

a driver circuit configured to drive the plurality of electrodes,

wherein the driver circuit includes a plurality of driver ICs coupled in common to an electrode with respect to each of the plurality of electrodes, and the plurality of driver ICs coupled in parallel supply electric currents to said electrode in a temporally staggered manner so as to drive each of the plurality of electrodes.

With this arrangement, the parallel connection of the driver ICs provides a measure to cope with heat generation, and these driver ICs can achieve both the function of a scan driver and the function of a sustain circuit, resulting in a reduced number of devices used in the driver circuit, thereby achieving cost reduction.

The second invention is configured based on the plasma display apparatus of the first invention, such that each of the driver ICs include a plurality of output nodes, each of which is coupled to a corresponding one of the plurality of electrodes.

With this provision, the driver ICs can properly be arranged with respect to a large-screen plasma display apparatus.

The third invention is configured based on the plasma display apparatus of the first or second invention, such that at least one of the driver ICs coupled in common to an electrode with respect to each of the plurality of electrodes is operative to receive two types of voltages corresponding to a high level and a low level, and is operative to provide three output states inclusive of a high-level output, a low-level output, and a high-impedance output.

With this provision, it is possible to perform digital signal control while preventing a through current at the time of signal switching.

The fourth invention is configured based on the plasma display apparatus of the second or third invention, such that at least one of the driver ICs coupled in common to an electrode with respect to each of the plurality of electrodes is capable of controlling the output nodes separately from each other.

This makes it possible for the driver ICs to scan the electrodes in the address period of a display cell drive sequence.

The fifth invention is configured based on the plasma display apparatus of one of the first through fourth inventions, such that the plurality of electrodes are Y electrodes, and the driver ICs output address pulses and/or sustain pulses.

This makes it possible to perform the drive sequence both in the Y-electrode address period and in the sustain period while suppressing heat generation.

The sixth invention is configured based on the plasma display apparatus of one of the first through fifth inventions, such that the driver circuit is configured such that the plurality of driver ICs are grouped into a first group and a second group with respect to each of the plurality of electrodes, a high-level input node of the driver ICs belonging to the first group being coupled to a positive electrode of a power supply, a low-level input node of the driver ICs belonging to the first group being coupled to a negative electrode of the power supply, and a low-level input node of the driver ICs belonging to the second group and a high-level input node of the driver ICs belonging to the second group being coupled to a substantially middle potential of the power supply via a coil and a diode.

This makes it possible to reduce the number of devices used in the driver circuit, thereby reducing circuit cost.

The seventh invention is configured based on the plasma display apparatus of one of the first through fifth inventions, such that the driver circuit is configured such that the plurality of driver ICs are grouped into a first group and a second group with respect to each of the plurality of electrodes, a high-level input node of the driver ICs belonging to the first group being coupled to a positive electrode of a power supply, a low-level input node of the driver ICs belonging to the second group being coupled to a negative electrode of the power supply, and a low-level input node of the driver ICs belonging to the first group and a high-level input node of the driver ICs belonging to the second group being coupled to a substantially middle potential of the power supply via a coil and a diode.

With this arrangement, it is possible to make the current passing through the driver ICs of the first group equal to the current passing through the driver ICs of the second group, thereby distributing the amount of heat evenly to these groups. Heat generation is thus distributed efficiently.

The eighth invention is configured based on the plasma display apparatus of the sixth or seventh invention, such that the plurality of electrodes are capacitive loads, and the coil, the diode, and the capacitive loads together constitute a power-recovery circuit based on an LC resonance circuit.

This serves to improve the power efficiency of the plasma display apparatus.

A plasma display apparatus according to a ninth invention includes:

a plurality of electrodes; and

a driver circuit configured to drive the plurality of electrodes,

wherein the driver circuit includes a plurality of semiconductor output devices coupled in common to an electrode with respect to each of the plurality of electrodes, the semiconductor output devices including an array of diodes configured to prevent electrical coupling between the electrodes, and the plurality of driver ICs coupled in parallel supply electric currents to said electrode in a temporally staggered manner so as to drive each of the plurality of electrodes.

This arrangement achieves a plasma display apparatus that uses externally-attached diodes for the purpose of heat suppression, thereby achieving further price reduction.

The tenth invention is configured based on the plasma display apparatus of the ninth invention, such that the plurality of electrodes are capacitive loads, and a high-level input node and low-level input node of the array of diodes are coupled to a coil, the coil and the capacitive loads together constituting a power-recovery circuit based on an LC resonance circuit.

This arrangement makes it possible to reduce price by use of the diode array and also to improve the power efficiency of the plasma display apparatus.

According to the present invention, a plasma display apparatus is provided in which the number of devices used is reduced, and heat generation is suppressed while reducing the cost of the driver circuit.

### BRIEF DESCRIPTION OF THE DRAWINGS

FIG. 1 is a drawing showing a basic configuration of a related-art surface-discharge-type plasma display apparatus provided with three-types of electrodes;

FIG. 2 is a drawing showing the drive waveforms of a plasma display apparatus shown in FIG. 1;

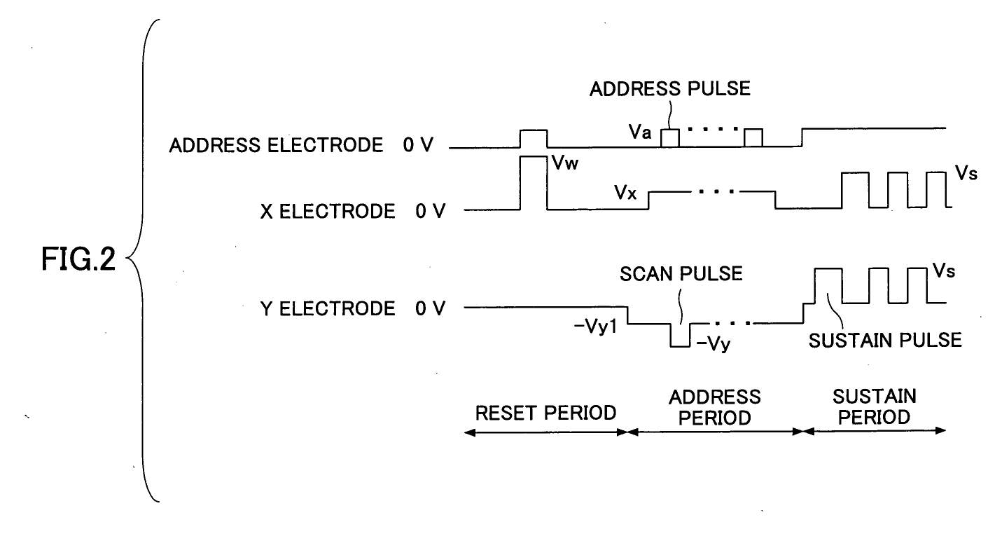

FIG. 3 is a drawing showing an example of the configuration of a Y-electrode drive circuit provided with a related-art power recovery circuit;

FIG. 4 is a drawing showing an example of a sustain voltage waveform and an electric current waveform appearing in the related-art Y-electrode drive circuit, in which (a) shows an example of a sustain voltage waveform, and (b) shows a sustain current waveform corresponding to the sustain voltage waveform;

FIG. 5 is a drawing showing relationships between the Y electrodes and output nodes of driver ICs of a related-art Y scan driver;

FIG. 6 is a block diagram showing a first embodiment of a plasma display apparatus;

FIG. 7 is a block diagram showing a circuit configuration of a driver circuit and a plasma display panel according to the first embodiment;

FIG. 8 is a drawing showing the sustain waveforms of the first embodiment of the plasma display apparatus, in which (a) shows an output voltage waveform, and (b) shows a sustain current waveform;

FIG. 9 is a diagram showing a circuit configuration of a driver circuit that is used in a plasma display apparatus according to a second embodiment;

FIG. 10 is a drawing showing the sustain waveforms of the second embodiment of the plasma display apparatus, in which (a) shows a sustain voltage waveform, and (b) shows a sustain current waveform; and

FIG. 11 is a diagram showing a circuit configuration of a driver circuit that is used in a plasma display apparatus according to a third embodiment.

### DESCRIPTION OF THE PREFERRED EMBODIMENTS

In the following, the best mode for carrying out the present invention will be described in detail by referring to the accompanying drawings.

### First Embodiment

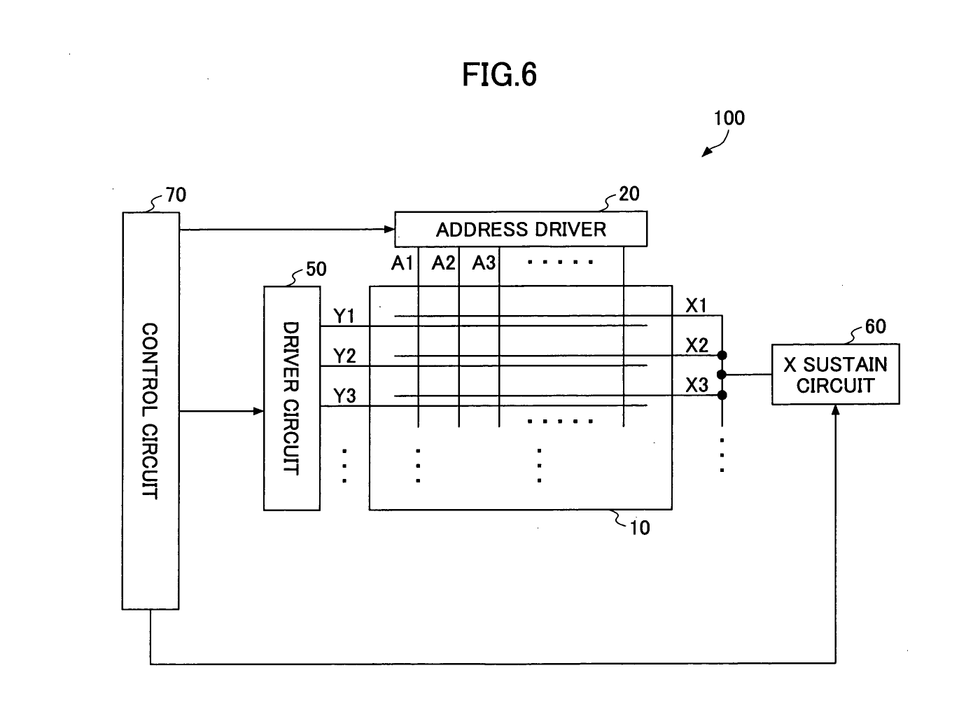

FIG. 6 is a block diagram showing a first embodiment of a plasma display apparatus according to the present invention.

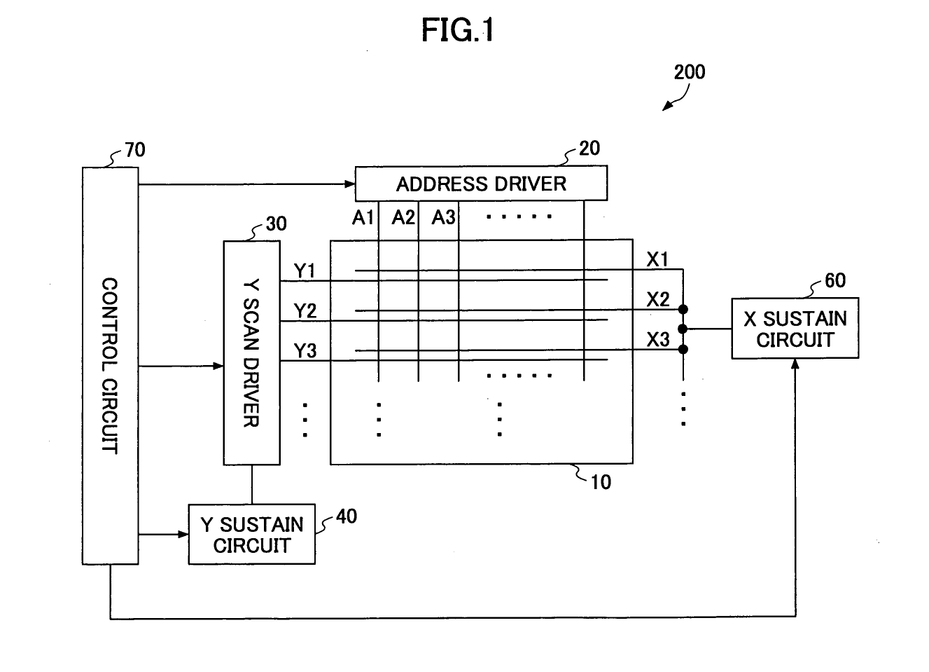

In FIG. 6, a plasma display apparatus 100 of the first embodiment includes a plasma display panel 10, an address driver 20, a driver circuit 50, an X sustain circuit 60, and a control circuit 70. The plasma display apparatus 100 of the first embodiment shown in FIG. 6 differs from the related-art plasma display apparatus shown in FIG. 1 in that the Y scan driver 30 and the Y sustain circuit 40 are removed, and the driver circuit 50 is additionally provided. Other constituent elements are the same as those shown in FIG. 1, and are referred to by the same reference numerals. A description of these elements will be omitted.

The driver circuit 50 serves to drive the electrodes constituting display cells (not shown) provided in the plasma display panel 10. The driver circuit 50 can drive the electrodes in both the address period and the sustain period of an electrode drive sequence. The driver circuit 50 can thus be suitably used for the Y electrodes that need to be driven in both the address period and the sustain period. This is, however, not intended to be a limiting example.

In the related-art configuration, the Y scan driver 30 drives the Y electrodes in the address period, and the Y sustain circuit 40 drives the Y electrodes in the sustain period. The driver circuit 50, on the other hand, can by itself drive the Y electrodes in both periods. The driver circuit 50 has a circuit configuration that is simpler than the drive circuit 55 made by combining the Y scan driver 30 and the Y sustain circuit 40 in a straightforward manner. The number of devices used therein is smaller, thereby achieving a configuration that can be implemented at low cost.

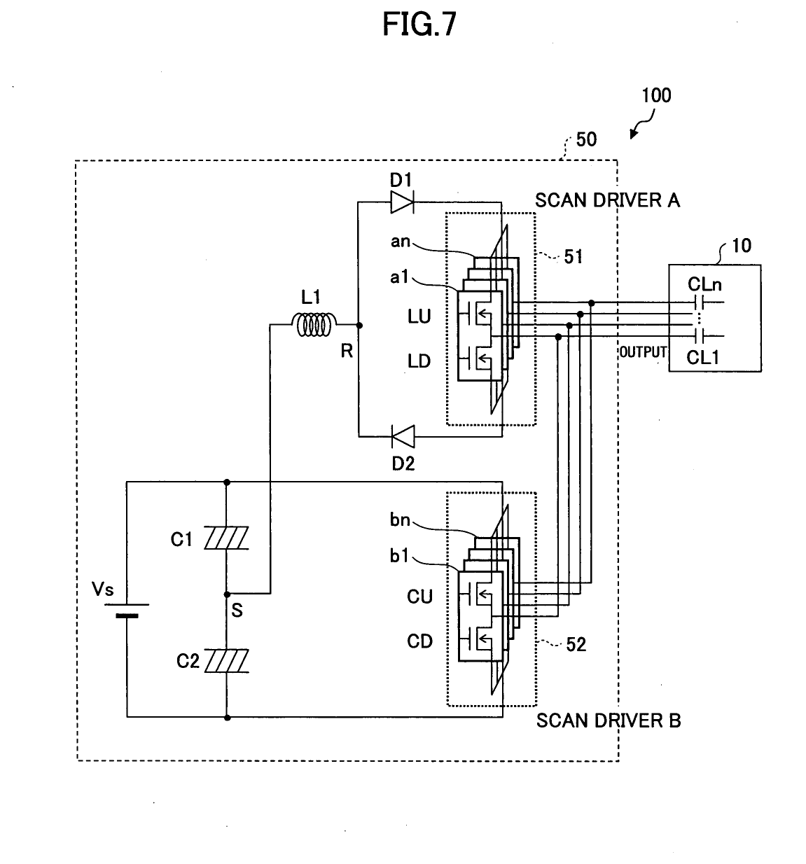

In the following, the driver circuit 50 of the plasma display apparatus 100 of the first embodiment will be described in detail with reference to FIG. 7.

FIG. 7 is a block diagram showing a circuit configuration of the driver circuit 50 and the plasma display panel 10 according to the first embodiment. In FIG. 7, the driver circuit 50 provided in the plasma display apparatus 100 of the first embodiment includes a plurality of electrodes CL1, . . . , CLn serving as capacitive loads in terms of their electrical characteristics, a scan driver A 51, a scan driver B 52, diodes D1 and D2, a coil L1, condensers C1 and C2, and a power supply Vs.

The electrodes CL1, . . . , CLn are the capacitive loads that constitute the display cells of the plasma display panel 10. The electrodes CL1, . . . , CLn may be Y electrodes, for example, and may correspond to Y electrodes Y1, . . . , Yn. The electrodes CL1, . . . , CLn may be disposed all over the plasma display panel 10 such as to substantially cover the entirety of the plasma display panel 10.

The scan driver A 51 and the scan driver B 52 serve to apply voltages and supply currents to the electrodes CL1, . . . , CLn, and may be implemented as driver ICs having a plurality of outputs. A driver IC serving as the scan driver A 51 includes a plurality of sets al through an of transistors LU and LD providing a plurality of outputs, which are coupled to the respective electrodes CL1, . . . , CLn. A driver IC serving as the scan driver B 52 includes a plurality of sets b1 through bn of transistors CU and CD providing a plurality of outputs, which are coupled to the respective electrodes CL1, . . . , CLn.

The scan driver A 51 and the scan driver B 52 are coupled in parallel to each other, and are coupled to a common electrode CLn, for example. This arrangement makes it possible that generated heat is distributed to the scan driver A 51 and the scan driver B 52. As far as the circuit function is concerned, only one of the scan driver A 51 and the scan driver B 52 may be necessary. In this embodiment, however, both the scan driver A 51 and the scan driver B 52 are coupled in parallel to a common electrode CLn so as to distribute generated heat, thereby reducing heat generation.

The scan driver B 52 includes plural sets of the transistors CU and CD. The source of the transistor CU of each set is coupled to the drain of the transistor CD of the same set, and a joint point thereof is coupled to a corresponding one of the electrodes CL1, . . . , CLn. It should be noted that n sets of the transistors CU and CD are provided in one-to-one correspondence to the electrodes CL1, . . . , CLn, and each set is coupled to the corresponding one of the electrodes CL1, . . . , CLn.

In the scan driver B 52, the drain of the transistor CU of each set is coupled to the positive polarity side of the power source Vs, and the source of the transistor CD of each set is coupled to the negative polarity side of the power source Vs. These transistors serve to achieve the same function as that of the transistors CU and CD of the related-art sustain circuit 40. The scan driver B 52 produces a high-level voltage when the transistor CU is turned on, and produces a low-level voltage when the transistor CD is turned on. The transistor CU and transistor CD are turned on/off at respective switch timings. If these switch timings are not aligned, an ON signal may overlap an OFF signal, so that a through current may flow from the high-potential-side transistor to the low-potential-side transistor. In order to prevent such through current, the transistors CU and CD may be configured such that a high impedance output is possible.

The scan driver B 52 can produce a pulse signal based on the switching of on/off states of the transistors CU and CD, thereby scanning the electrodes CL1, . . . , CLn in the address period of a drive sequence that drives the electrodes CL1, . . . , CLn. The plural sets of the transistors CU and CD are coupled in one-to-one correspondence to the electrodes CL1, . . . , CLn, so that the scan driver B 52 is configured as a driver IC that is capable of producing a scan output separately for each of the electrodes CL1, . . . , CLn. The scan driver B 52 may be configured as such a driver IC that the plurality of its outputs include at least one output that is controllable separately from the others, or that the plurality of its outputs are controllable separately from one another.

It should be noted that the scan driver B 52 does not have to be implemented as a single unitary IC. The electrodes that constitute the plasma display panel 10 may be divided into groups (e.g., Y1 through Y64, Y65 through Y128, and so on), and the scan driver B 52 may be provided for each one of the groups. In this case, the plasma display apparatus 100 as a whole has a plurality of scan drivers B 52. Namely, a plurality of scan drivers B 52 (e.g., driver ICs B1 through Bm) may be provided in the plasma display apparatus 100, and these driver ICs collectively serve as a set of scan drivers B 52. Such a set of scan drivers B 52 may be referred to as a first group.

Like the scan driver B 52, the scan driver A 51 includes plural sets of the transistors LU and LD. The source of the transistor LU of each set is coupled to the drain of the transistor LD of the same set, and a joint point thereof serves as an output node. This output node is coupled to a corresponding one of the electrodes CL1, . . . , CLn. The drain of the transistor LU of each set is coupled to one end of the coil L1 via the diode D1, and the other end of the coil L1 is coupled to a joint point S between the condenser C1 and the condenser C2 that divide the power supply voltage Vs. The source of the transistor LD of each set is coupled to one end of the coil L1 via the diode D2, which is provided in parallel to the diode D1.

The scan driver A 51 constitutes a power recovery circuit, and the coil L1 and the capacitive loads of the electrodes CL1, . . . , CLn together constitute an LC resonance circuit. When the transistors LU are turned on, an electric current runs through the diode D1 in a forward direction, and is supplied from the sources of the transistors LU to the capacitive loads of the electrodes CL1, . . . , CLn. LC resonance occurs based on the coil L1 and the electrodes CL1, . . . , CLn, and the power-recovery condensers C1 and C2 recover the electric power. When the transistors LD are turned on, on the other hand, an electric current output from the sources of the transistors LD runs through the diode D2 in a forward direction. In response to this current, LC resonance occurs based on the coil L1 and the electrodes CL1, . . . , CLn, and the power-recovery condensers C1 and C2 recover the electric power.

Like the scan driver B 52, the scan driver A 51 may be implemented as a driver IC having a plurality of output nodes. Alternatively, plural sets of scan drivers A 51 may be provided to cover all the electrodes of the plasma display panel 10. Provision may be made such that the output nodes include at least one node that is controllable separately from the others, or such that all the output nodes are controllable separately from one another. Such a set of scan drivers A 51 may be referred to as a second group of driver ICs.

During the address period of a drive sequence of the driver circuit 50 that drives the electrodes CL1, . . . , CLn as described above, the scan driver A 51 does not operate, and the scan driver B 52 operates to output pulse signals. Namely, although the scan driver A 51 and the scan driver B 52 are coupled in parallel to the electrodes CL1, . . . , CLn, the scan driver A 51 and the scan driver B 52 do not simultaneously produce output signals to these electrodes during the address periods. In the plasma display apparatus 100 of this embodiment, thus, there is no need to consider the risks of having timing misalignment between the scan driver A 51 and the scan driver B 52 during the address period and having a through current caused by the overlapping of a rising edge and a falling edge of the output pulses during the address period.

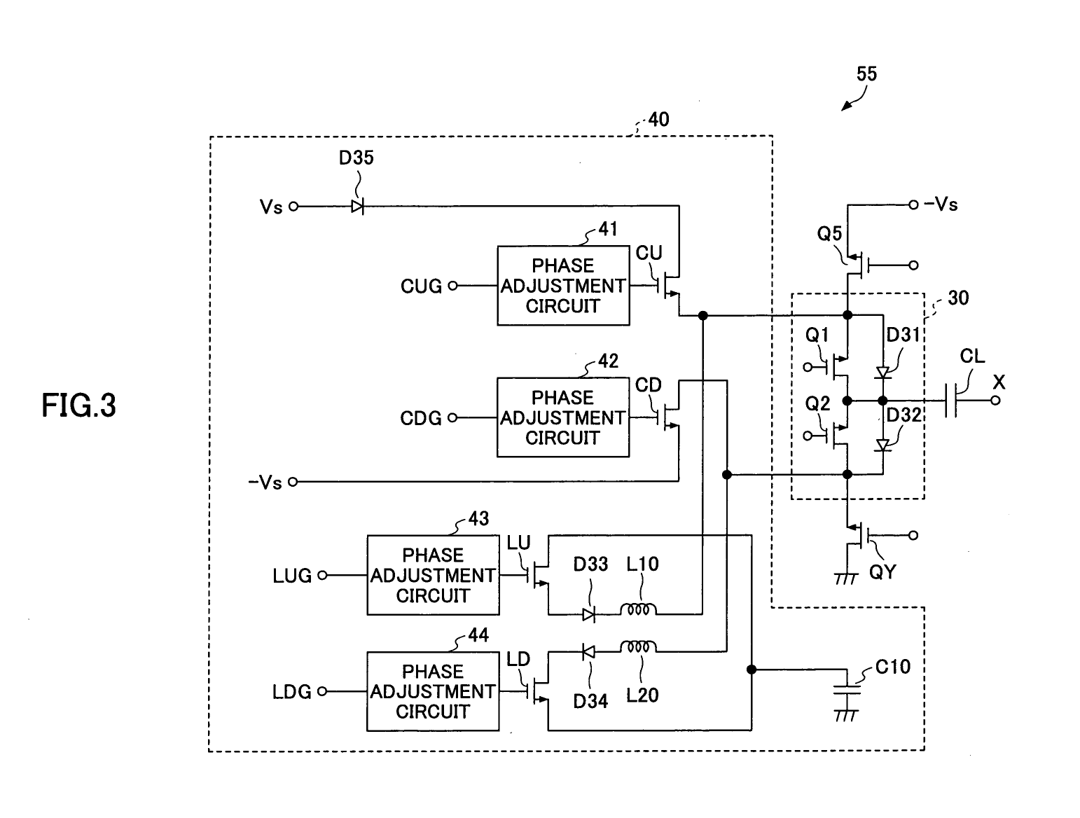

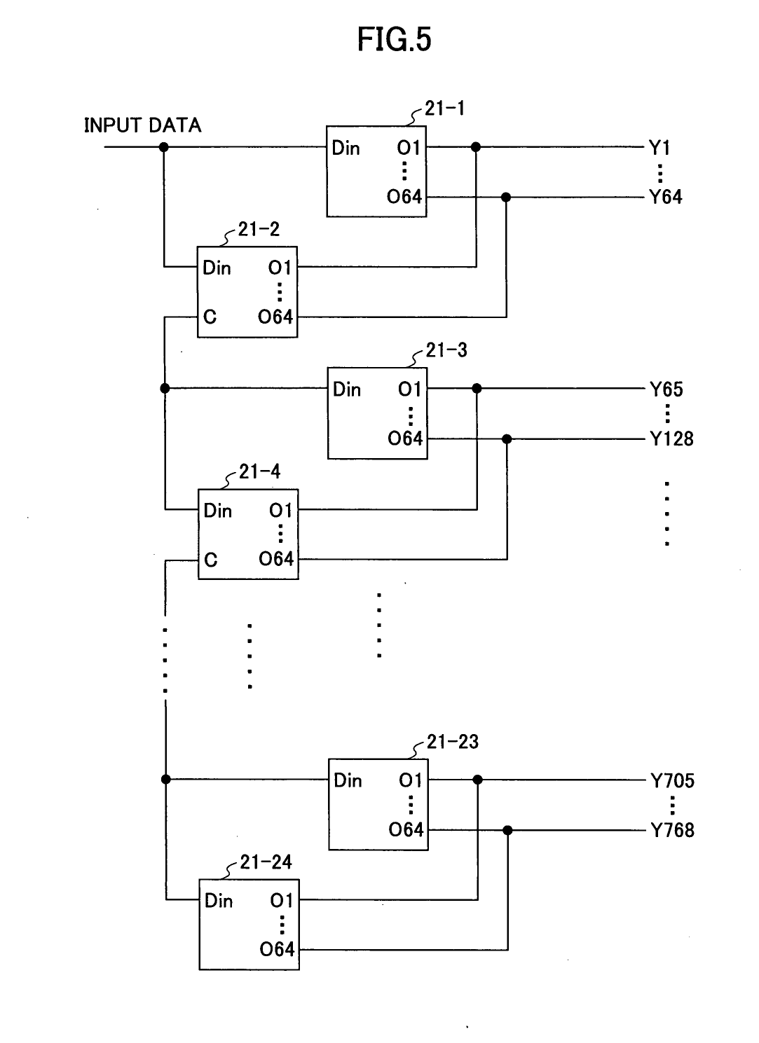

In the Y-electrode drive circuit 55 of the related-art plasma display apparatus 200 described in connection with FIG. 3, the transistors CU and CD of the sustain circuit 40 are provided in addition to the transistors Q1 and Q2 of the Y scan driver for driving individual electrodes. In this embodiment, on the other hand, the scan driver B 52 not only serves to achieve the functions of the transistors Q1 and Q2, but also serves to achieve the functions of the transistors CU and CD. In using the related-art Y scan driver 30, the switching function is only used in the address period even when the Y scan driver 30 includes the parallel configuration as shown in FIG. 5. In the driver circuit 50 of the plasma display apparatus 100 of this embodiment, on the other hand, this switching function is also used in the sustain period, thereby making it possible to remove the transistors CU, CD, LU, and LD used in the related-art sustain circuit. This can achieve cost reduction.

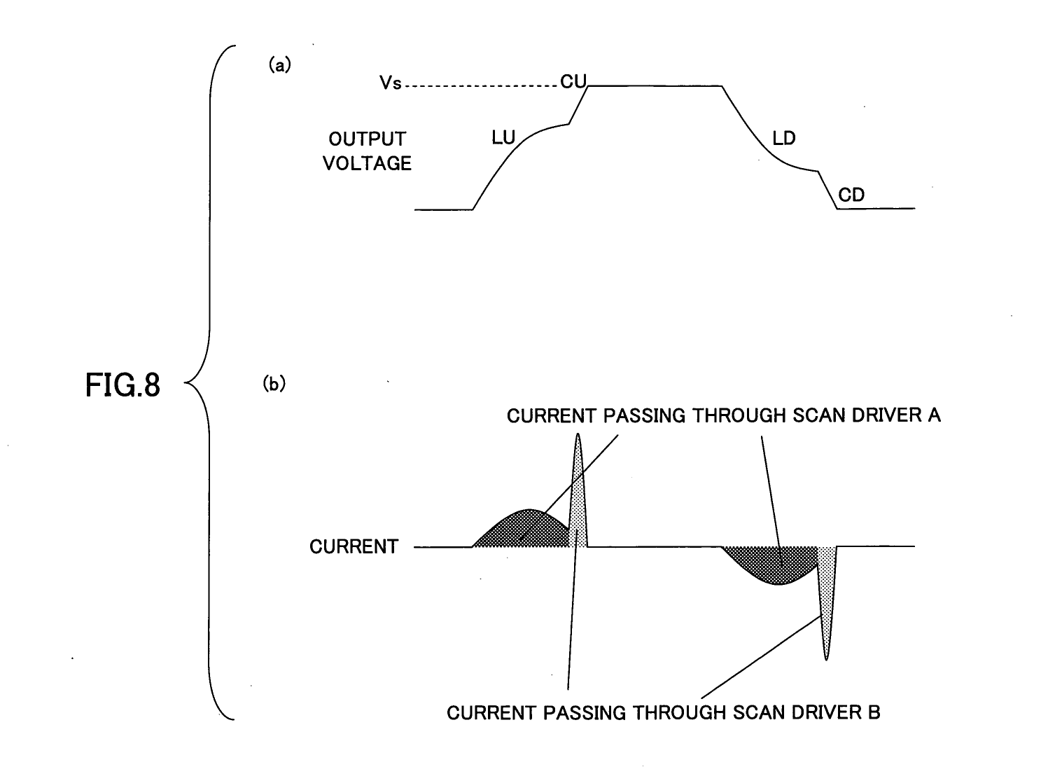

In the following, the sustain waveforms appearing during the sustain period of the drive sequence for driving the electrodes CL1, . . . , CLn of the plasma display apparatus 100 of the first embodiment shown in FIG. 7 will be described with reference to FIG. 7 and FIG. 8.

FIG. 8 is a drawing showing sustain waveforms appearing during the operation of the plasma display apparatus 100 of the first embodiment.

FIG. 8-(a) shows the output voltage waveform appearing during the sustain period of the plasma display apparatus 100 with respect to a single electrode CLn. In FIG. 8-(a), the transistor LU is first turned on, so that a voltage corresponding to a midpoint potential of the sustain power supply Vs is supplied to the coil L1 from the joint point S between the condensers C1 and C2, resulting in the flow of an electric current. The electric current runs through the diode D1 in a forward direction, and is output through the transistors LU, so that a sustain current is supplied from the scan driver A 51 to the capacitive load of the electrode CLn. LC resonance is generated between the coil L1 and the capacitive load CLn, and causes the output voltage of the transistor LU to rise gently as shown in FIG. 8-(a). The transistor CU of the scan driver B 52 is turned on when the output voltage reaches a certain level based on the LC resonance, thereby outputting the sustain power supply voltage Vs. The sustain power supply voltage Vs is thereafter maintained as an output. At the falling edge of the pulse, the transistor CU is turned off, and the transistor LD is turned on. In so doing, the transistor CU may be set to a high-impedance output so as to prevent a through current from flowing through the transistor CU. As the transistor LD is turned on, the charge accumulated in the capacitive load CLn flows into the coil L1 via the transistor LD and the diode D2. LC resonance is thus generated, resulting in a gentle drop in the sustain voltage waveform. When the output voltage drops to a certain potential through the LC resonance, the transistor CD is turned on to set the output to a ground potential of 0 V.

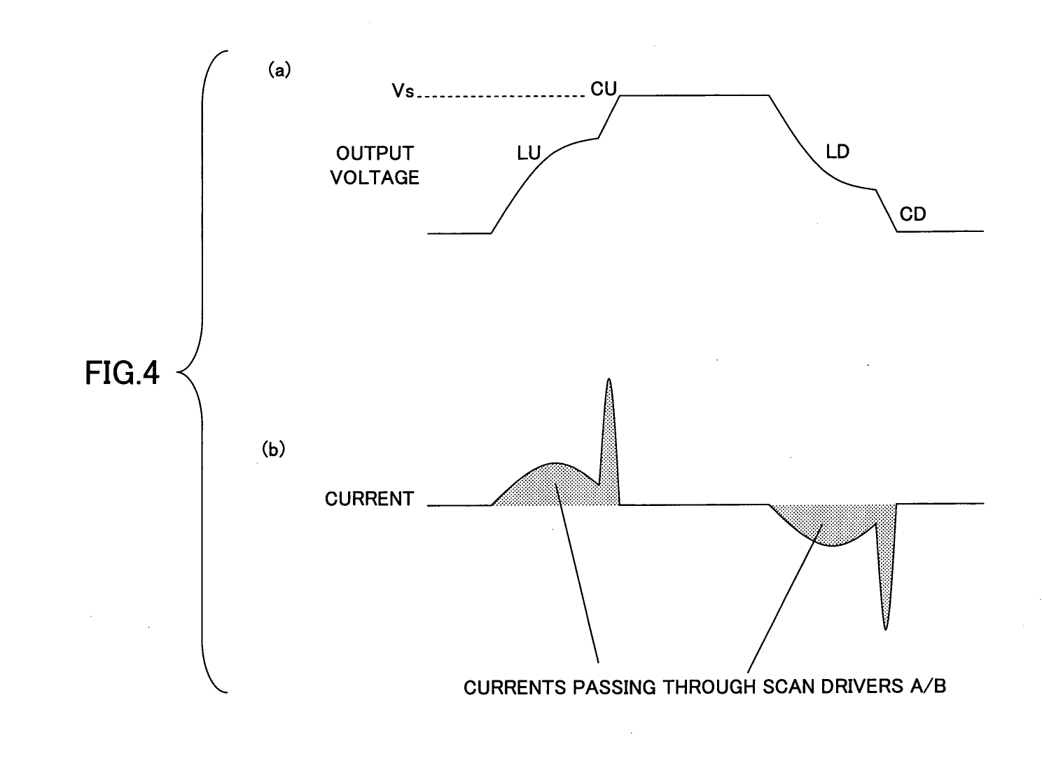

In this manner, the transistors LU and LD of the driver IC constituting the scan driver A 51 and the transistors CU and CD of the driver IC constituting the scan driver B 52 are turned on such that their outputs are staggered in a time dimension, so that the sustain voltage waveform as shown in FIG. 8-(a) is obtained. This waveform is the same as the related-art sustain voltage waveform described in connection with FIG. 4-(a), but such same sustain waveform is achieved by use of a smaller number of devices. In the related-art drive circuit 55 shown in FIG. 3, the transistors CU, CD, LU, and LD are used in the sustain circuit 40, and the transistors Q1 and Q2 are used in the Y scan driver 30, which results in the use of six transistors in total. In the driver circuit 50 of the present embodiment, on the other hand, the transistors CU, CD, LU, and LD, i.e., four devices in total, can achieve the same function. Namely, the scan driver A 51 incorporates the functions of the transistors LU and LD of the related-art sustain circuit 40, and the scan driver B 52 incorporates the functions of the transistors CU and CD of the related-art sustain circuit 40, thereby eliminating the standalone sustain circuit 40. With this arrangement, it is possible to implement the sustain-waveform-generation function by use of the scan driver A 51 and the scan driver B 52. This makes it possible to implement the driver circuit 50 by use of a smaller number of transistors, thereby reducing circuit cost.

FIG. 8-(b) shows temporal changes in the sustain current waveform. The sustain waveform shown in FIG. 8-(b) is the same as the related-art sustain waveform shown in FIG. 4-(b), but the smaller number of devices again achieves the same functions. Accordingly, a heat suppression effect is achieved in the same manner as in the related art, but this advantage is achieved by use of a smaller number of devices.

It may appear that the heat suppression effect attributable to the distribution of heat sources is substantially the same when the scan driver A 51 and the scan driver B 52 of the driver circuit 50 of the plasma display apparatus 100 according to the present embodiment are compared with the related-art Y scan driver 30. In the related-art configuration shown in FIG. 3, however, the transistors Q1 and Q2 of the Y scan driver 30 generates heat based on the sustain current waveform as shown in FIG. 8-(b), and, also, the transistors CU, CD, LU, and LD generate heat. Since the number of devices is reduced in the plasma display apparatus 100 of the present embodiment and so is the number of heat sources, the total amount of heat generation should thus be smaller than in the case of the related-art drive circuit 55. Accordingly, the plasma display apparatus 100 according to the first embodiment can not only achieve cost reduction based on the use of a smaller number of devices in the driver circuit 50, but also offers a further improvement by reducing heat generation when the plasma display apparatus 100 is considered as a whole.

Although FIG. 8 was described with reference to the output waveforms of the driver IC corresponding to a single electrode, it should be noted that there are a plurality of Y electrodes, so that the sustain waveforms shown in FIG. 8 may as well be supplied to each of these electrodes.

In the current waveforms passing though the scan driver A 51 and the scan driver B 52 shown in FIG. 8-(b), the current running through the scan driver A 51 has a sinusoidal-like waveform having a smaller peak and extending longer in both the positive polarity side and the negative polarity side. The current running through the scan driver B 52, on the other hand, has a pulse-like waveform having a larger peak and shorter temporal width both in the positive polarity side and in the negative polarity side. In this manner, the current running through the scan driver A 51 and the current running through the scan driver B 52 are not exactly the same. These currents may be adjusted by changing the characteristics of the transistors CU, CD, LU, and LD in response to the difference in the currents such that the integrated values of the currents become substantially the same. The current allocation and heat allocation to the scan driver A 51 and the scan driver B 52 may properly be adjusted by taking into account the state of operation and heat generation of the plasma display apparatus 100.

### Second Embodiment

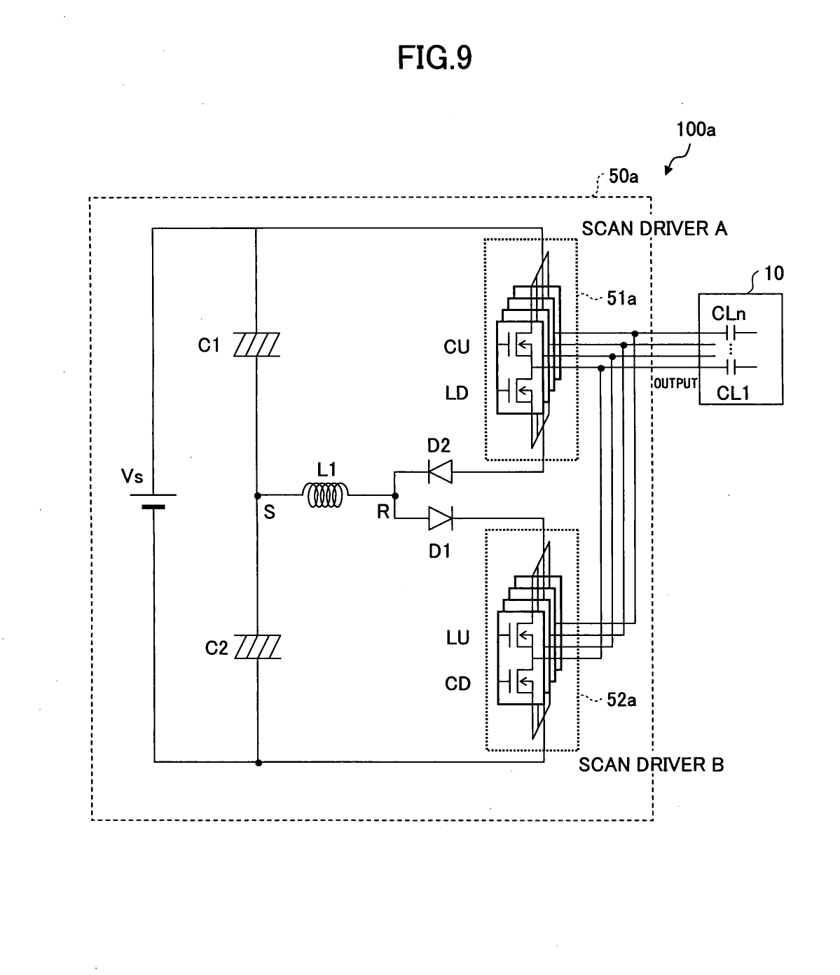

FIG. 9 is a block diagram showing a circuit configuration of a driver circuit 50a that is used in a plasma display apparatus 100a according to the second embodiment. The overall configuration of the plasma display apparatus 100a of the second embodiment may properly be the same as that of the first embodiment shown in FIG. 6. The same elements as those already described are referred to by the same numerals, and a description thereof will be omitted.

The plasma display apparatus 100a of the second embodiment shown in FIG. 9 differs from the plasma display apparatus 100 of the first embodiment in the combinations of transistors used in a scan driver A 51a and a scan driver B 52a and the circuit configuration of the driver circuit 50a.

The scan driver A 51a or a second group of driver ICs is comprised of transistors CU and LD in FIG. 9. The scan driver B 52a or a first group of driver ICs is comprised of transistors LU and CD.

In this manner, the scan driver A 51a and the scan driver B 52a of the second embodiment are configured in such a manner that the transistor LU of the scan driver A 51 of the first embodiment and the transistor CU of the scan driver B 52 of the first embodiment are swapped. Along with this swapping, the diode D1 coupled to the transistor LU in the first embodiment is moved together with the transistor LU, such that the parallel connection of the diodes D1 and D2 to the connection point R of the coil L1 is maintained. Accordingly, the configuration of the driver circuit 50a of the plasma display apparatus 100a according to the second embodiment is the same as that of the first embodiment in terms of electrical connections of each component with respect to the transistors CU, CD, LU, and LD. Further, the number of devices inclusive of the transistors CU, CD, LU, and LD is the same as that of the plasma display apparatus 100 of the first embodiment, so that circuit cost is the same.

In the following, the operation in the address period of the plasma display apparatus 100a of the second embodiment provided with the driver circuit 50a described above will be described.

In the address period, the transistor CU of the scan driver A 51a is turned on when a high-level voltage is to be output, so that the power supply voltage Vs is output via the source node of the transistor CU. The transistor CD of the scan driver B 52a is turned on when a low-level voltage is to be output, so that a ground voltage of 0 V is output via the drain node of the transistor CD. These output signals are output from the scan driver A 51a and the scan driver B 52a in a temporally staggered manner, resulting in address pulses being applied to the electrodes CL1, . . . , CLn. At the timing of switching between the “on” state and “off” state of the transistors CU and CD, the output node may be set to a high-impedance state, such that no through current runs from the high-voltage-side transistor CU to the low-voltage-side transistor CD.

In the second embodiment as described above, the use of the transistor CU of the scan driver A 51a coupled to the positive-polarity side of the power supply Vs and the transistor CD of the scan driver B 52a coupled to the negative-polarity side of the power supply Vs makes it possible to drive the electrodes CL1, . . . , CLn in the address period in the same manner as in the first embodiment. In the second embodiment, the transistors CU and CD used in the address period are distributed to the scan driver A 51a and to the scan driver B 52a. With such arrangement, it is possible to make the amount of current running through the scan driver A 51a equal to the amount of current running through the scan driver B 52a, thereby achieving equal amount heat generation in these drivers.

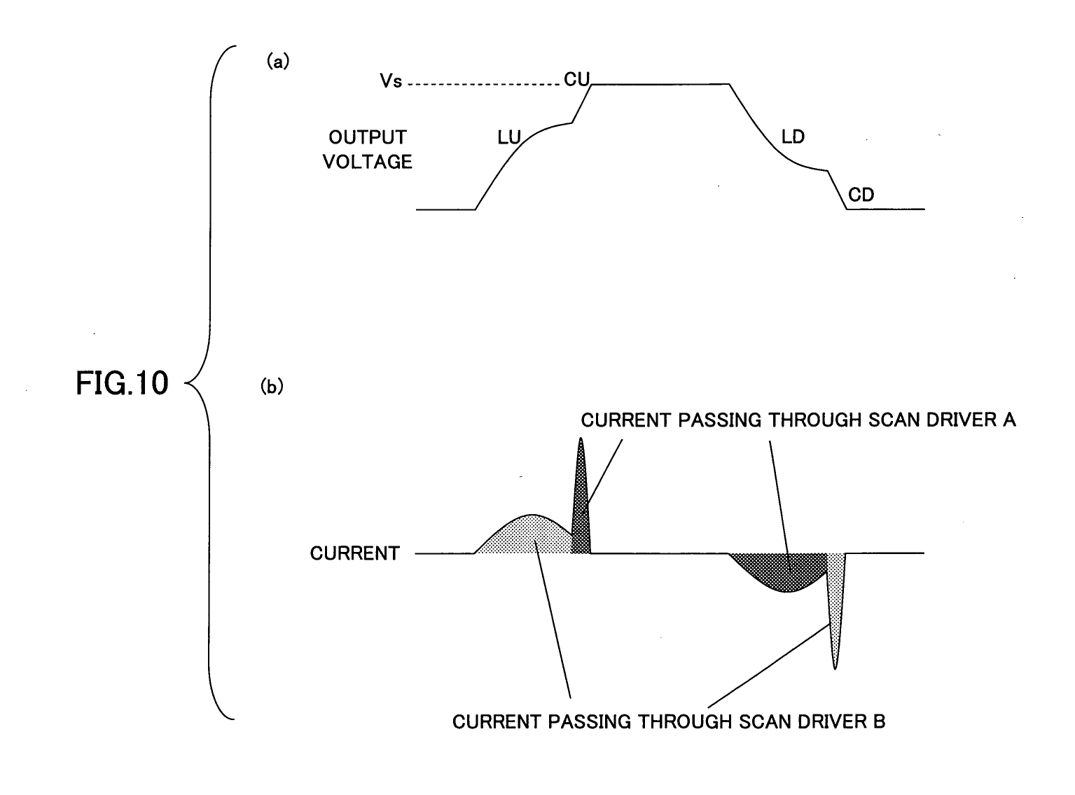

In the following, the operation of the driver circuit 50a in the sustain period will be described with reference to FIG. 9 and FIG. 10.

FIG. 10 is a drawing showing sustain waveforms appearing during the operation of the plasma display apparatus 100a of the second embodiment. FIG. 10-(a) shows temporal changes in the sustain voltage waveform.

In FIG. 10-(a), the transistor LU of the scan driver B 52a is turned on at an initial rise of the voltage, so that a voltage corresponding to a midpoint potential of the sustain power supply Vs is supplied from the joint point S between the condensers C1 and C2, and is output from the source node of the transistor LU as a sustain voltage after passing through the coil L1 and diode D1. LC resonance occurs based on the coil L1 and the electrodes CL1, . . . , CLn, and the sustain voltage shows a gentle rise as shown in FIG. 10-(a). The transistor CU of the scan driver A 51a is turned on when the voltage reaches a certain level, so that a high-level voltage equal to the power supply voltage Vs is output via the source node of the transistor CU. In order to prevent a through current, the output of the transistor LU may be set to a high-impedance state in this instance. Further, an electric power is accumulated in the power-recovery-purpose condensers C1 and C2.

The output voltage is maintained at the sustain power supply voltage Vs for some duration of time. The transistor LD is then turned on at a drop of the sustain voltage. The electrodes CL1, . . . , CLn supply voltages via the transistors LD and the diode D2, so that LC resonance occurs based on the coil L1 and the capacitive loads of the electrodes CL1, . . . , CLn. The sustain output voltage gently falls due to the LC resonance. When the output voltage drops to a certain level, the transistor CD of the scan driver B 52a is turned on, thereby setting the sustain voltage to a ground voltage of 0 V. During this LC resonance, the condensers C1 and C2 may recover an electric power.

FIG. 10-(b) shows a sustain current output waveform corresponding to the sustain voltage output waveform shown in FIG. 10-(a).

The current passing through the scan driver B 52a in FIG. 10-(b) is the currents that pass through the transistors LU and CD, and is comprised of a positive, gentle sustain current corresponding to an initial rise passing through the transistor LU and a negative, sharp sustain current corresponding to an ending fall passing through the transistor CD.

The current passing through the scan driver A 51a in FIG. 10-(b) is the currents that pass through the transistors CU and LD, and is comprised of a positive, sharp current corresponding to a rise passing through the transistor CU and a negative, gentle current corresponding to a fall passing through the transistor LD.

Accordingly, each of the current passing through the scan driver B 52a and the current passing through the scan driver A 51a is a combination of a gentle current waveform and a sharp current waveform having opposite polarities, so that the current passing through the scan driver A 51a and the current passing through the scan driver B 52a have the same integrated value. This makes it possible to distribute the amount of heat generation equally to the scan driver A 51a and the scan driver B 52a during the sustain period, thereby achieving an improved efficiency in terms of heat distribution. The effectiveness of heat suppression in the plasma display apparatus 100a is thus further improved. Moreover, the number of devices is identical to that of the first embodiment, so that the advantage of simultaneous attainment of suppression of heat generation and reduction of circuit costs is also maintained.

### Third Embodiment

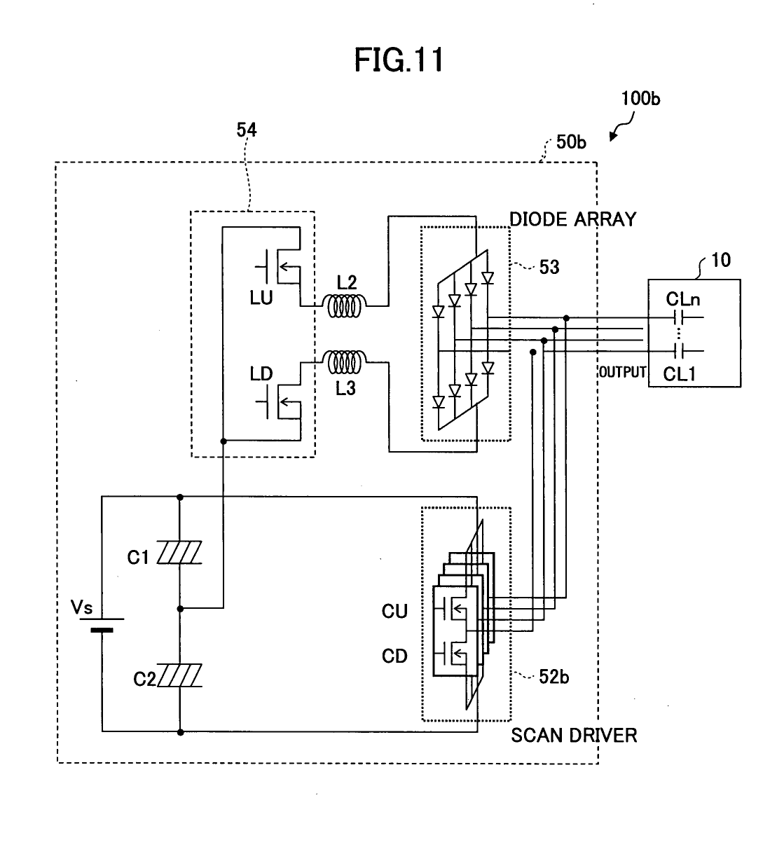

FIG. 11 is a block diagram showing a circuit configuration of the plasma display panel 10 and a driver circuit 50b used in a plasma display apparatus 100b according to the third embodiment. The overall configuration of the plasma display apparatus 100b of the third embodiment may properly be the same as that of the first embodiment shown in FIG. 6. The same elements as those already described are referred to by the same numerals, and a description thereof will be omitted.

In FIG. 11, the driver circuit 50b used in the plasma display apparatus 100b of the third embodiment includes a diode array 53, a scan driver 52b, coils L2 and L3, transistors LU and LD, condensers C1 and C2, and a sustain power supply Vs.

The driver circuit 50b of the plasma display apparatus 100b of the third embodiment shown in FIG. 11 differs from the driver circuit 50 of the plasma display apparatus 100 of the first embodiment shown in FIG. 7 in that the scan driver A 51 is replaced with the diode array 53 capable of producing individual outputs in addition to the coils L2 and L3 and the transistors LU and LD having the same configuration as the related-art power-recovery circuit.

In the first and second embodiments, the driver ICs connected in parallel to each other for use as the scan driver are identical ICs. These driver ICs, however, do not have to be identical. As a matter of fact, it suffices if at least one of the driver ICs connected in parallel is capable of driving an output separately from the others. In the address period in which outputs need to be separately controlled, an electric current has a small integrated current amount because the frequency of occurrence in a unit time period is small. Because of this, heat generation during such address period may not really be a problem.

In consideration of this, the plasma display apparatus 100b of the third embodiment is configured such that the driver IC on the power-recovery-circuit side among all the driver ICs connected in parallel to each of the electrodes CL1, . . . , CLn are implemented as a driver IC 54 including the transistors LU and LD that are not capable of performing individual output control. Although the driver IC 54 is not capable of performing individual output control, its outputs coupled to the respective electrodes CL1, . . . , CLn are separate from each other. Since there is a need to prevent short-circuiting between adjacent outputs, a device for preventing a reverse current such as the diode array 53 becomes necessary.

In this embodiment, the scan driver B 52b serves to perform individual control, and also achieves the function of the transistors CU and CD used in the related-art sustain circuit 40, thereby making it possible to eliminate the need to provide these devices as dedicated components. With this arrangement, it is possible to remove the two transistors CU and CD of the related-art sustain circuit 40. As for the remaining transistors LU and LD, the diode array 53 is used in place of these transistors to provide a power recovery circuit having a similar configuration to the related-art configuration. The configuration of the driver circuit 50b of this embodiment using simpler devices than the scan driver B 52 of the first embodiment may provide cost advantage, and/or may be easier to manufacture. In such case, provision may be made such that a scan driver B 52b of a sustain-circuit-embedded type is used according to need.

As described above, the present invention is applicable to various embodiments that differ in terms of how to incorporate the Y sustain circuit 40 in the scan driver 51, 51a, 52, 52a, or 52b. A proper embodiment may be selected and used according to need.

Further, the present invention is not limited to these embodiments, but various variations and modifications may be made without departing from the scope of the present invention.

The present application is based on Japanese priority application No. 2007-124808 filed on May 9, 2007, with the Japanese Patent Office, the entire contents of which are hereby incorporated by reference.

What is claimed is:

1. A plasma display apparatus, comprising:
a plurality of electrodes; and
a driver circuit configured to drive the plurality of electrodes,
wherein the driver circuit includes a plurality of driver ICs coupled in common to an electrode with respect to each of the plurality of electrodes, and the plurality of driver ICs supply electric currents to said electrode in a temporally staggered manner so as to drive each of the plurality of electrodes.

2. The plasma display apparatus as claimed in claim 1, wherein each of the driver ICs include a plurality of output nodes, each of which is coupled to a corresponding one of the plurality of electrodes.

3. The plasma display apparatus as claimed in claim 2, wherein at least one of the driver ICs coupled in common to an electrode with respect to each of the plurality of electrodes is operative to receive two types of voltages corresponding to a high level and a low level, and is operative to provide three output states inclusive of a high-level output, a low-level output, and a high-impedance output.

4. The plasma display apparatus as claimed in claim 3, wherein at least one of the driver ICs coupled in common to an electrode with respect to each of the plurality of electrodes is capable of controlling the output nodes separately from each other.

5. The plasma display apparatus as claimed in claim 4, wherein the plurality of electrodes are scan electrodes, and the driver ICs output address pulses and/or sustain pulses.

6. The plasma display apparatus as claimed in claim 5, wherein the driver circuit is configured such that the plurality of driver ICs are grouped into a first group and a second group with respect to each of the plurality of electrodes,
a high-level input node of the driver ICs belonging to the first group being coupled to a positive electrode of a power supply,
a low-level input node of the driver ICs belonging to the first group being coupled to a negative electrode of the power supply,
and a low-level input node of the driver ICs belonging to the second group and a high-level input node of the driver ICs belonging to the second group being coupled to a substantially middle potential of the power supply via a coil and a diode.

7. The plasma display apparatus as claimed in claim 5, wherein the driver circuit is configured such that the plurality of driver ICs are grouped into a first group and a second group with respect to each of the plurality of electrodes,
a high-level input node of the driver ICs belonging to the first group being coupled to a positive electrode of a power supply,
a low-level input node of the driver ICs belonging to the second group being coupled to a negative electrode of the power supply,
and a low-level input node of the driver ICs belonging to the first group and a high-level input node of the driver ICs belonging to the second group being coupled to a substantially middle potential of the power supply via a coil and a diode.

8. The plasma display apparatus as claimed in claim 6, wherein the plurality of electrodes are capacitive loads, and the coil, the diode, and the capacitive loads together constitute a power-recovery circuit based on an LC resonance circuit.

9. The plasma display apparatus as claimed in claim 7, wherein the plurality of electrodes are capacitive loads, and the coil, the diode, and the capacitive loads together constitute a power-recovery circuit based on an LC resonance circuit.

10. The plasma display apparatus as claimed in claim 1, wherein at least one of the driver ICs coupled in common to an electrode with respect to each of the plurality of electrodes is operative to receive two types of voltages corresponding to a high level and a low level, and is operative to provide three output states inclusive of a high-level output, a low-level output, and a high-impedance output.

11. The plasma display apparatus as claimed in claim 1, wherein the plurality of electrodes are scan electrodes, and the driver ICs output address pulses and/or sustain pulses.

12. The plasma display apparatus as claimed in claim 1, wherein the driver circuit is configured such that the plurality of driver ICs are grouped into a first group and a second group with respect to each of the plurality of electrodes,
a high-level input node of the driver ICs belonging to the first group being coupled to a positive electrode of a power supply,
a low-level input node of the driver ICs belonging to the first group being coupled to a negative electrode of the power supply,
and a low-level input node of the driver ICs belonging to the second group and a high-level input node of the driver ICs belonging to the second group being coupled to a substantially middle potential of the power supply via a coil and a diode.

13. The plasma display apparatus as claimed in claim 1, wherein the driver circuit is configured such that the plurality of driver ICs are grouped into a first group and a second group with respect to each of the plurality of electrodes,
a high-level input node of the driver ICs belonging to the first group being coupled to a positive electrode of a power supply,
a low-level input node of the driver ICs belonging to the second group being coupled to a negative electrode of the power supply,
and a low-level input node of the driver ICs belonging to the first group and a high-level input node of the driver ICs belonging to the second group being coupled to a substantially middle potential of the power supply via a coil and a diode.

14. A plasma display apparatus, comprising:
a plurality of electrodes; and
a driver circuit configured to drive the plurality of electrodes,
wherein the driver circuit includes a plurality of semiconductor output devices coupled in common to an electrode with respect to each of the plurality of electrodes, the semiconductor output devices including an array of diodes configured to prevent electrical coupling between the electrodes, and the plurality of semiconductor output devices supply electric currents to said electrode in a temporally staggered manner so as to drive each of the plurality of electrodes.

15. The plasma display apparatus as claimed in claim 14, wherein the plurality of electrodes are capacitive loads, and a high-level input node and low-level input node of the array of diodes are coupled to a coil, the coil and the capacitive loads together constituting a power-recovery circuit based on an LC resonance circuit.
